(19) United States
(12) Patent Application Publication
(10) Pub. No.: US 2002/0028880 A1
(43) Pub. Date: Mar. 7, 2002

(54) Modified thermoplastic composition and method of production of same

(76) Inventor: Grant W. Doney, Surrey (CA)

Correspondence Address: Frank P. Presta, Nixon & Vanderhye, P.C., 1100 North Glebe Road, 8th floor, Arlington, VA, 22201, US

(21) Appl. No.: 09/865,722

(22) Filed: May 29, 2001

(30) Foreign Application Priority Data
May 26, 2000 (CA) 2,309,508

(51) Int. Cl. C08F 8/00

(52) U.S. Cl. 525/107

(57) ABSTRACT

A process for creating a polymer of increased flexural modulus, toughness and tensile strength, comprised of an interpenetrating network (“IPN”) of a secondary polymer which is intensely dispersed within a first polymer, utilizing at least one isocyanate reacted with a catalyst. The composition has improved mechanical and processing properties rendering it useful as a moldable resin.

The present discovery relates to a thermoplastic consisting of an interpenetrating network (“IPN”) which exhibits high melt strengths.

### BACKGROUND OF THE INVENTION

Production of polyethylene terephthalate (“PET”) consisting of an interpenetrating network (“IPN”), which exhibits high melt strengths and other favorable characteristics, is known in the art. An IPN is comprised of a secondary polymer which is intensely dispersed within a first incompatible polymer. In U.S. Pat. No. 4,409,167 (Kolouch et al), a process is described of coupling an incompatible polymer with PET to produce a PET blend resin in the presence of isocyanate with a much increased melt strength. However, this process does not result in the formation of an interpenetrating network.

It is also well understood that there are limitations pertaining to polymer, and specifically PET, processability which tend to limit the thickness of finished products, such as sheet in amorphous phase, this being due to the crystallization which occurs in heavy wall materials, rendering the product brittle and non formable in secondary processes. Polystyrene, when used as a foam, has a very broad process window of typically 50° F., whereas the ranges in which crystalline or semi-crystalline polyesters foam are very narrow, as described in U.S. Pat. No. 5,288,764. It would be desirable to provide a PET resin that overcomes these narrow processing parameters.

There have been many attempts to address this melt strength problem by means of branching and/or thermal melt addition of dissimilar polymers such as nylon, polycarbonate, polyethylene, etc., as described for example in U.S. Pat. Nos. 4,981,631 (Cheung et al), 5,288,764 (Rotter et al), and 5,696,176 (Kheimani et al). Continued difficulties persist in this prior art insofar as resolving the need to expand the process window while at the same time maintaining the thermal stability of products produced from such compositions and processes. This is especially true in cases of low intrinsic viscosity (“IV”) PET, such as recycled bottle stock, which has repeated heat histories that have lowered the IV to below acceptable levels. Virgin PET with intrinsic viscosities below 0.8 also must be enhanced by addition of expensive branching and nucleating agents in order to produce acceptable foam or other lightweight products. Such branching agents still fail to sufficiently expand the temperature range needed for maximum processability of PET, and thus limit the applications in which these modified PETs can be used.

Previous endeavors which have been made to solve the problem relating to the abrupt transition between the melt crystalline temperature window and the lower temperature required to maintain die melt strength have had limited success, such as U.S. Pat. Nos. 5,000,991 and 5,134,028 (Hyashi et al), which attempt to address some of the problems through the use of branching agents such as PMDA. This approach often produces levels of unreacted PMDA or other residue heat stabilizers that exceed minimum health requirements and arc extremely detrimental in the case of food applications such as vacuum formed food trays.

U.S. Pat. No. 5,364,908 (Oishi et al) demonstrates a means with which to produce a high melt compound based on PET by prereacting a number of vinyls, polyesters, polymides, polyethers and polyurethanes, and melt blending them in the presence of isocyanates or epoxy resins in the presence of a diisocyanate. This process requires a separate step to create a polymer, which is used to compatabilize dissimilar polymers, and does not do so in situ in order to form an IPN. This process describes a means with which to compatabilize dissimilar polymers by first creating a dispersant pre-polymer that has functionality similar to at least one of the primary resins. It is also necessary to pre-form a compatabilizer and thereafter melt blend it into the dissimilar polymers. No mention is made in the disclosures of that patent regarding the production of low-density materials. Furthermore, the compositions thus produced are used to secondarily compatabilize dissimilar polymers in the presence of diisocyanates while melt blending. This requires a complete secondary costly process and further does not address the need to limit the percentages of low thermal stable polymers. This process fails to address the much desired need for ail impact modified PET which both has the thermal stability and can be done in situ in a single step. Further, this prior art teaches nothing of the needs pertaining to impact improvements as relate to lighter density products. This leads to a limited usage and application such as extruded products where shape and form must be maintained until cooled.

### SUMMARY OF THE INVENTION

The present invention is directed at the production of polymers, including PET, having a minuscule IPN of a secondary polymer which is intensely dispersed within said first incompatible polymer, utilizing at least one isocyanate reacted with a catalyst, which results in increased melt strength, impact resistance, flexural modulus, tensile strength and crystallization rate. The composition thus produced has greater stiffness and resistance to yield at elevated temperatures which renders it especially useful for foamed articles that require rigidity and toughness, such as construction foam board, food packaging applications and wood like replacement. The thermoplastic PET compound produced by means of the present invention also exhibits the much sought after characteristics required for solid forms such as injection molding, extruded solid products, blow molding, and the like.

In addition to this modified thermoplastic product, the process for producing same is disclosed. The process provides a method of greatly lowering the percentage to weight of the lower thermally stable secondary polymer in the TPN which is needed to impart sufficient impact strength and other properties to the first polymer. The present invention also reduces or eliminates the need for costly branching agents in order to obtain the desired mechanical and processing properties. The process comprises creating a thermoplastic composition by dynamic melt blending of the following components at a melt temperature: a first polymer; a secondary polymer; at least one catalyst; and at least one isocynate or epoxy compound.

Also disclosed is a single phase process for producing a compound based on polyethylene terephthalate (“PET”) and blends of polyethylene terephthalate, and aliphatic and aromatic polyolefins, polymerised with organic diisocyanates (whether aromatic, aliphatic, or cycloaliphatic) or epoxy compounds, in the presence of a catalyst or catalysts, which results in the creation of an interpenetrating network (IPN) structure. The resulting polymer composition exhibits highly increased melt, impact, tensile, and flexural strengths. The subsequent polymers of this discovery facilitate the manufacture of fine closed cell foams having marked improvements in low temperature and general flexural strength. Polymers produced by the present invention further exhibit improvements in rates of crystallization, thus enhancing processability in the amorphous phase for applications such as thermoformed articles where secondary processing is employed. Polymer compounds of the present invention further show improved melt strength, and are therefore capable of being extruded into thick sheet, profiles, pre-forms, and injection molded or blow molded articles. Thermoformed articles from compounds produced through the present discovery exhibit extremely high draw ratios at increased crystallization levels.

More specifically, the compound exhibits unusual and beneficial characteristics that facilitate the creation of both extremely low density foamed articles and high density solid polymers, both of these being characterized by increased impact, flex, and melt strengths as well as other much sought after advantages. The IPN is formed with relatively low levels (often 10 weight percent or less) of secondary polymers, created in situ in a single step process which forms co-continuous structures within the main first polymer. The advantage of creating this IPN polymer in situ, while foaming, is that it results in the production of a micron size cell structure capable of forming extremely low-density material with very improved mechanical properties, capable of utilizing a broad temperature processing window. Foams that are produced with the present invention facilitate a marked reduction in gas requirements for foaming, and further contribute to a reduction in the use of expensive and detrimental additives such as branching agents normally required.

### DETAILED DESCRIPTION OF THE PREFERRED EMBODIMENTS

As outlined in general above, the present invention is a modified polymer product and a process for producing same. The modified polymer product has desirable processing qualities and parameters as well as broad uses. It is particularly contemplated that the present invention will have utility in the production of a modified polyethylene terephthalate (PET), wherein PET would be used as the first polymer in the product. It will be understood, however, that the process of the present invention could also be practiced on other first polymers and any other such first polymer is also contemplated within the scope of the present invention.

It has been the practice in the prior art to impart improved mechanical properties to PET by large additions of either a dissimilar polymer or a compatabilizer to produce the desired properties in the end composite, whether diisocyanates were employed or not. The lower melt characteristics of the modifying polymer taught in the prior art have greatly inhibited applications where high temperature thermal stability in finished products is mandated, such as food trays for oven-bakeable applications, under-hood applications in automotive engineering, or for high temperature insulation foams. This discovery enables the production of a modified PET which is capable of achieving the higher service temperature applications, without the need for large amounts of expensive impact modifying polymers such as SEBS or thermally unstable impact modifying secondary polymers, previously needed to mechanically improve the base PET.

Novel thermoplastic composition:

The modified thermoplastic composition of the present invention is created from the blending of a melted first polymer together with a secondary polymer in the presence of a catalyst, together with at least one isocyanate or epoxy compound. Generally speaking it is intended that the first polymer which is modified using this process, resulting in the creation of interpenetrating networks therein, is polyethylene terephthalate. It will however be understood that it might be obvious to one skilled in the art to alter or modify this composition by using a different first polymer, and such other polymers and attendant obvious alterations in the process or composition are contemplated within the scope of the present invention. The first polymer could also be any crystalline polymer or modified PET as described in “Modern Plastics, Encyclopedia 98”. The precise method of production of this modified thermoplastic composition is outlined in further detail below.

It is contemplated that the PET or other first polymer would comprise between 60 to 99 percent by weight of the total components used in the creation of the thermoplastic composition, and that any amount of first polymer in this range is contemplated within the scope of the present invention.

Whether the first polymer is PET or otherwise, it is intended that the raw PET resin or first polymer used in the creation of the composition of the present invention could either be virgin thermoplastic material, or alternatively could come from scrap or recycled sources. It will be understood that the process and composition of the present invention are particularly useful in the production of the thermoplastic composition of the present invention using scrap or recycled PET since the process of the present invention will allow for the strengthening of the first polymer which might otherwise be degraded from previous heating or manipulation. It will be understood that the use of any grade of PET resin or other first polymer is contemplated within the scope of the invention as claimed.

Where recycled or scrap polymers are used, it will be understood that there might be residues of barrier-coatings, such as polyamides or florocarbons, present in same, which will not effect the process or its output detrimentally.

By using minor amounts of secondary polymers with lower melt temperatures, the product yielded retains the much desired thermal properties of the crystalline PET or other similar first polymer. Practicing of this invention produces thermoplastics, and specifically PET, that can retain their high thermal stability. It is contemplated that the quantity of secondary polymer would be in the range of 1 to 40 weight % of the first polymer present in the composition. It will be understood that any secondary polymer inclusion within this range is contemplated within the scope of the present invention. The secondary polymer disclosed in the example outlined below is polyethylene, but it will be understood that other polycarbomides or other polymers might also be used as the secondary polymer in the composition of the product of the present invention and that such changes will also be contemplated within the scope of the present invention. Without limiting the generality of the foregoing, other specific secondary polymers which are contemplated are any aliphatic and aromatic polyolefins, or polyamides or EVA copolymers, and specifically polyethylene, ethylene vinyl acetate or polypropylene.

Dependent upon the desired end result, the first polymer and secondary polymer used might either be compatible or incompatible, also known as similar or dissimilar, for blending purposes, which will yield different results from the blending process. It will be understood that any combination of compatible or incompatible first and secondary polymers is contemplated within the scope of the present invention.

The product of the present invention produces foams at extremely high-elevated temperatures, often in the range of 490° F. to 520° F., which all prior art fails to accomplish. Hence extremely low-density foamed products with high melt strengths and greatly increased impact resistance can be produced, thereby allowing the polymeric composition of the present invention to be formed into previously impossible configurations. Much desired higher rates of throughput can be attained as well, due to eliminating the requirement of extensive cool down, as is the case in tandem line foaming apparatus used to make foam sheet for packaging.

The catalyst which is used might either be added as a separate ingredient, or in some cases might actually be compounded into the secondary polymer being used in the composition of the product of the present invention. The catalyst, it is contemplated, would generally speaking be used in the amount of 0.001 to 5.0 weight % of the first polymer, depending on the type or combination of catalysts being used and the desired results.

Also, the catalyst component may contain a degree of chemical foaming agent and dispersant, with which to regulate the rate and degree with which the IPNs are formed. Various types of chemical foaming agents and dispersants could be used and it will be understood that all such agents and dispersants are contemplated within the scope of the present invention. Non polar hydrocarbon foaming agents may be used, separately or in combination with chemical blowing agents that enhance the dispersion and structure of the IPNs such as 5-Phenyltetrazole. The present invention answers the difficulties encountered in the prior art in production of foams over a wide temperature range Foams produced through this invention also exhibit melt strengths and surface smoothness uncharacteristic of prior art. Without limiting the generality of the types of hydrocarbon foaming agents which could be used, it is contemplated that they might be selected from the group of: isopentane, cyclopentane, carbon dioxide, n-pentane, nitrogen, butane, isohexane, heptane and chlorodifloro-methane.

It will be obvious to one skilled in the art various types of catalysts which could be used in the process and reaction of the present invention, and it is intended that all such catalysts are contemplated within the scope of the claims herein. Without limiting the generality of the foregoing, however, it is contemplated that the catalysts might be one or more nucleating agent, such as polymethyl siloxane or selections from the group including talc, calcium fluoride, sodium phenylphosphinate, aluminum oxide, titanium dioxide, finely divided polytetrafluoroethylene, teflon, or pyromellitic dianhydride (PMDA), sulfuric acid, ron oxide or any base earth metal groups, and/or might be one or more catalysts selected from the following: dibutyltin dilaurate, maleate, precursors for phenolic resin, urea, melamine, dioctyltia dilaurate, sulphuric acid, sodium acetate, zinc chloride, carbomide, 5-phenyltetrazole, tert-butyl peroxy 2-ethylhexyl carbonate, tert-butyl peroxy-3,5,5-trimethylhexanoate, 2,5-Dimethyl-2,5-di(tert-butylperoxy)hexane, tert-butyl peroxybenzoate. The catalysts might be one or more of these types of compounds.

While the isocyanate discussed above is methylenediphenylene diisocyanate (“MDI”), it will be understood that any number of other isocyanates or derivatives of isocyanates, such as diisocyanates or triisocyanates, could be used and it will be understood that all such isocyanates and derivatives thereof are contemplated within the scope of the claimed invention. Without limiting the generality of the foregoing, it is contemplated that some of the isocyanates which might be used are 4,4′- pbenylmethane diisocyanate (MDI), polymethylene polyphenyl, polyisocyanate (PAPI).

The compositions made possible by the present disclosure are a result of dynamic curing of the isocyanate in the presence of a catalyst which both serves to transitionally cure the carrier resin while polymerizing the isocyanate, thus forming minute interpenetrating networks which act as membranes to any foam cells which are formed in situ in the PET or other first polymer resin. It is this aspect, namely the formation of the interpenetrating network, as has been discovered, that causes the extremely fine dispersion and retention of closed foam cells, even at extremely high die exit temperatures, e.g. 500° F. This is done without the need to branch the PET as described in much of the prior art. The IPN composition formed also produces solid polymers with much improved mechanical properties without the loading of large amounts of modifying secondary polymers as the prior arts teach. This makes the properties of the composition thus produced far more resemble those of the parent PET than the trade-off properties which are experienced when employing the prior art.

Epoxy compounds could also be employed in the production of the modified PET or first polymer of the present invention. Various epoxy compounds could be used and it will be understood that all such epoxy compounds are contemplated within the scope of the present invention, but without limiting the generality of the foregoing it is specifically thought that the epoxy compounds might include phenols, bisphenols, aromatic epoxy resin and cycloaliphatic epoxy resin. As well, it will be understood that more than one isocyanate and/or epoxy compound might be used in a blend. It is contemplated that isocyanates or epoxy compounds will be present in the amount of over 0.01 weight percent of the first polymer used in the composition. It will be understood that variations in the components the secondary polymer, the catalyst or catalysts and the isocyanates or epoxy compounds, as dictated by the application to which the compound is to be applied, arc contemplated within the scope of the present invention as well.

An oxygen barrier such as vinyl siloxane could also be added to the product of the present invention and it will be understood that variations in the oxygen barrier employed are also contemplated within the scope of the present invention. Similarly various heat stabilizers could be employed, which it will also be understood are contemplated within the scope of the present invention.

The method of blending employed in the production of the modified thermoplastic composition of the present invention can have a controlled and preferable effect on the final product as well. If an aggressive or dynamic blending process is employed a more homogenous product will be yielded, since the dynamic blending will cause the size of the particle dispersion in the IPNs created to diminish. A homogenous product such as this with a lower dispersion will yield a higher tensile strength thermoplastic composition. Alternatively, it may also in certain circumstances be desired to produce a thermoplastic composition with a lower tensile characteristic or the like, in which case a more passive blending method might be employed. It will be understood that both types of thermoplastic composition, namely those produced by dynamic or non-dynamic blending, as well as the process of the present invention employing either dynamic or non-dynamic blending, are contemplated within the scope of the present invention.

The product, a modified thermoplastic composition of a first primary polymer, of the present invention exhibits better attributes than a standard sample of said first polymer. For example, where the first polymer is PET the present invention yields a product with a markedly higher intrinsic viscosity than a standard PET sheet. The following graph shows the intrinsic viscosity of a sheet of modified PET (marked as Davilon thereon) of the present invention in comparison to a standard PET sheet:

[chemical structure]

Similarly, the product of the present invention also exhibits other better material properties than a standard sample of a first polymer being PET or otherwise. For example, the thermoplastic composition of the present invention will exhibit a better co-efficient of thermal expansion, greater tear strength, increased flexural modulus, improved elongation or tensile strength characteristics and/or Garnder impact performance than standard samples of the first polymer being modified in accordance with the present invention.

Method of production of thermoplastic composition:

The discussion of the product, thermoplastic composition, above it will be understood is equally applicable to the details of the process of production of same outlined below. As outlined in the claims hereof, the modified thermoplastic composition produced by the process of the present invention is produced by the dynamic melt blending of the various components. The most preferred method of producing the compounds is by way of melt blending in a thermoplastic extruder. Either a single or twin screw extruder could be used. Alternatively, an application unit such as an injection molding unit could also be used to perform the melt blending operation to produce the modified PET of the present invention. It will be understood that any other type of an apparatus which can be used to melt blend the composition of the present invention is also contemplated within the scope hereof.

One preferred embodiment of the present invention is the utilization of a low IV (0.65 to 0.75) PET as the first polymer in combination with dibutyltin dilaurate together with linear low-density polyethylene and MDI. As outlined in detail herein, these components might be varied without departing from the scope of the claimed invention. In one example, a component batch of 97.17% by weight PET, 2% by weight linear low-density polyethylene, 0.03% DBTL (catalyst) and 0.8% MDI (methylenediphenylene diisocyanate) were processed at 530 degrees Fahrenheit in a barrier single screw extruder (30:1 LxD), and at the completion of the dynamic melt blending the dye exit temperature was 505 degrees Fahrenheit.

Preferably, the PET and catalyst, together with the polymer used to form the IPN structure, are introduced at the feed throat of the extruder, with the MDI injected at a port in the extruder barrel after melt blending has occurred, although in practice, the introduction of all components at the feed throat has proven quite satisfactory in producing the compounds described herein. The PET resin and compounds can be preblended and or dry blended provided the catalyst's sensitivity to heat is not an issue. Alternatively, such catalyst may be added separately at the feed throat.

The catalyst could be added or present at a level of 0.001 to 10.0 weight percent, based on the weight of the first polymer.

Weight percentages of catalyst MDI in the production of low-density foam may be in the area of 0.1 to 3.0 weight percentage of the first polymer, and, in the case of high-density non-foamed compounds, as high as 5 weight percent. The blended materials are heated during extrusion to a temperature in the range of 480° F. to 560° F., or at a minimum to the melt phase of the higher melt first polymer being incorporated, provided it does not exceed the temperature where the lower melt secondary polymer would deteriorate, with sufficient residency time as to allow the diisocyanate to be extensively dispersed and cured so as to create the IPN sub structure. The dynamic melt blending of the product could take place at any melt temperature which is sufficient to ensure at least two phases have 3-dimensional spatial continuity resulting from the dynamic curing in the presence of the catalyst. Tandem extrusion may be used where optimum characteristics and control of the finished composition or foam is preferred.

A hydrocarbon gas might be added during melt-blending. Other additives which might be added during the melt blending include one or more of antioxidants, stabilizers, dyes, flame-retardants, extenders, UV stabilizers and other processing aids. Where heat stabilizers are added to the process or product of the present invention, the heat stabilizer(s) might be compounded into an EVA carrier resin or vinyl based carrier resin or alternatively added directly during processing The carrier resin might be a polyolefin which comprises from 2 to 6 carbon atoms. Similarly, the catalyst might be added directly to the composition or process, or might be compounded into an elastomer for addition. Specifically, the catalyst might optionally be compounded into a CPE polyolefin.

Vinyl siloxane might also be added during the blending process, in a sufficient amount to form a surface oxygen barrier. Alternatively the PET composite might be coated with an oxygen inhibiting barrier coat compatible with the PET resin upon exiting the extruder or other blending unit.

The blended thermoplastic could be rapidly cooled upon exiting the blending vessel. It could be cooled in either sheet or pellet form, amongst others, dependent upon the secondary manufacturing processing requirements. Where foaming agents had been added in or shifted to a gaseous state during the blending, rapid cooling might optimally trap the foaming agent within the thermoplastic in a liquid phase such that in secondary manufacturing upon reheating of the PET product, the foaming agent would shift back to its gaseous state and the need for separate addition of foaming agents in secondary manufacturing could be lessened.

The product of any variation of the process of the present invention outlined herein, is contemplated within the scope of the claimed invention as well.

Thus it can be seen that the invention accomplishes all of its stated objectives. The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. A thermoplastic composition created from the melt blending of a first polymer together with a secondary polymer in the presence of a catalyst together with at least one isocyanate or epoxy compound.

2. The composition of claim 1 wherein an interpenetrating network is created with said thermoplastic composition.

3. A thermoplastic composition created from the blending of a melted first polymer together with a secondary polymer in the presence of a catalyst, together with at least one isocyanate or epoxy compound, said blending resulting in the formation of at least one interpenetrating network within said thermoplastic composition.

4. The composition of claim 1 wherein said secondary polymer is incompatible for blending with said first polymer.

5. The composition of claim 1 wherein said secondary polymer is compatible for blending with said first polymer.

6. The composition of claim 1 wherein said components are dynamically blended.

7. The composition of claim 1 wherein said components are not dynamically blended.

8. The composition of claim 1 wherein said secondary polymer is dissimilar to said first polymer.

9. The composition of claim 1 wherein said first polymer is polyethylene terephthalate.

10. The composition of claim 9 wherein an interpenetrating network is created within said thermoplastic composition.

11. The composition of claim 9 wherein said first polymer comprises between 60 to 99 weight percent of the total blend.

12. The composition of claim 1 wherein said first polymer is a recyclate.

13. The composition of claim 1 wherein said secondary polymer is a polycarbomide.

14. The composition of claim 1 wherein said catalyst is compounded into said secondary polymer in advance of blending.

15. The composition of claim 1 wherein said isocyanate or epoxy compound is methylenediphenylene diisocyanate (“MDI”).

16. The composition of claim 1 wherein the number of isocyanate or epoxy compounds is one.

17. The composition of claim 1 wherein the number of isocyanate or epoxy compounds is more than one.

18. The composition of claim 1 wherein said catalyst is present at a level of 0.001 to 5.0 weight percent, based on the weight of said first polymer.

19. The composition of claim 1 wherein said secondary polymer used is in the range of 1 to 40 weight percent of the total blend.

20. The composition of claim 1 wherein said isocyanate or epoxy compound used is in the range of 0.1 to 3.0 weight percent, based on the weight of said first polymer.

21. The composition of claim 1 further comprising vinyl siloxane as an oxygen barrier.

22. The composition of claim 1 further comprising at least one heat stabilizer component.

23. A process for creating a thermoplastic composition, said process comprising melt blending of the following components at a melt temperature:
a) a first polymer;
b) a secondary polymer;
c) at least one catalyst; and
d) at least one isocynate or epoxy compound.

24. The process of claim 23 wherein said thermoplastic composition contains at least one interpenetrating network.

25. The process of claim 23 wherein said melt blending is dynamic.

26. The process of claim 23 wherein said melt blending is not dynamic.

27. The process of claim 23 wherein said secondary polymer is incompatible for blending with said first polymer.

28. The process of claim 23 wherein said secondary polymer is dissimilar to said first polymer.

29. The process of claim 23 wherein said secondary polymer is compatible for blending with said first polymer.

30. The process of claim 23 wherein said first polymer is polyethylene terephthalate.

31. The process of claim 23 wherein an interpenetrating network is created within the thermoplastic composition.

32. The process of claim 23 wherein said secondary polymer is from the group of aliphatic and aromatic polyolefins.

33. The process of claim 23 wherein said secondary polymer is from the group: polyethylene, ethylene vinyl acetate or polypropylene.

34. The process of claim 23 wherein said at least one catalyst is a nucleating agent.

35. The process of claim 23 wherein said secondary polymer is a polyamite.

36. The process of claim 23 wherein said secondary polymer is an EVA copolymer.

37. The process of claim 23 wherein said nucleating agent is polydimethyl siloxane.

38. The process of claim 23 wherein said at least one catalyst is selected from the group: dibutyltin dilaurate, maleate, precursors for phenolic resin, urea, melamine, dioctyltin dilaurate, sulphuric acid, sodium acetate, zinc chloride, carbomide, 5-phenyltetrazole, tert-butyl peroxy 2-ethylhexyl carbonate, tert-butyl peroxy-3,5,5-trimethylhexanoate, 2,5-Dimethyl-2,5-di(tert-butylperoxy)hexane, tert-butyl peroxybenzoate.

39. The process of claim 38 wherein the number of catalysts is one.

40. The process of claim 38 wherein the number of catalysts is more than one.

41. The process of claim 23 wherein said isocynate is selected from the group: 4,4′-phenylmethane diisocyanate (MDI), polymethylene polyphenyl, polyisocyanate (PAPI).

42. The process of claim 23 wherein said epoxy is selected from the group: phenols, bisphenols, aromatic epoxy resin and cycloaliphatic epoxy resin.

43. The process of claim 23 wherein the melt temperature is sufficient to ensure at least two phases have 3-dimensional spatial continuity resulting from the dynamic curing in the presence of said catalyst.

44. The process of claim 23 further comprising addition of a hydrocarbon gas during blending.

45. The process of claim 23 wherein said first polymer is from a scrap source.

46. The process of claim 23 wherein residues of barrier-coatings are present in said first polymer.

47. The process of claim 46 wherein said barrier-coatings are polyamides or florocarbons.

48. The process of claim 23 further comprising the addition of at least one hydrocarbon foaming agent during said melt blending.

49. The process of claim 48 wherein said hydrocarbon foaming agent is selected from the group of: isopentane, cyclopentane, carbon dioxide, n-pentane, nitrogen, butane, isohexane, heptane and chlorodifloro-methane.

50. The process of claim 23 wherein said catalyst is at least one nucleating agent selected from the following group: talc, calcium fluoride, sodium phenylphosphinate, aluminum oxide, titanium dioxide, finely divided polytetrafluoroethylene, teflon, or pyromellitic dianhydride (PMDA), sulfuric acid, iron oxide or any base earth metal groups.

51. The process of claim 23 wherein said catalyst is added at a rate of between 0.001 to 5 weight percent, based on the weight of said first polymer.

52. The process of claim 23 further comprising the addition of at least one of the following additives during blending: antioxidants, stabilizers, dyes, flame-retardants, extenders, UV stabilizers and processing aids.

53. The process of claim 23 further comprising the addition of vinyl siloxane in a sufficient amount to form a surface oxygen barrier in the completed product.

54. The process of claim 23 wherein said melt blending is performed in an extruder.

55. The process of claim 54 further comprising coating said thermoplastic composition with an oxygen inhibiting barrier coat compatible with said first polymer upon its exiting the extruder.

56. The process of claim 23 wherein said melt blending is performed in an application unit.

57. The process of claim 56 wherein the application unit is an injection molder.

58. The process of claim 23 wherein said catalyst is present at a level of 0.001 to 10.0 weight percent, based on the weight of said first polymer.

59. The process of claim 23 further comprising the addition of at least one additional heat stabilizer during the melt blending.

60. The process of claim 59 wherein said catalyst and said additional heat stabilizer are compounded into an EVA carrier resin or vinyl base carrier resin

61. The process of claim 23 wherein said catalyst is compounded into an elastomer.

62. The process of claim 23 wherein said catalyst is compounded into a CPE polyolefin.

63. The process of claim 60 wherein the carrier resin is a polyolefin which comprises from 2 to 6 carbon atoms.

64. The process of claim 23 further comprising rapidly cooling the blended thermoplastic composition upon completion of the melt blending step.

65. The process of claim 48 wherein said at least one foaming agent changes phases from gas to liquid form upon cooling of the blended thermoplastic composition.

66. The process of claim 48 wherein said at least one foaming agent is present in the cooled thermoplastic composition in such a fashion that said thermoplastic composition can be foamed in secondary manufacturing.

67. The process of claim 64 wherein said blended thermoplastic is cooled in pellet form.

68. The process of claim 64 wherein said blended thermoplastic composition is cooled in sheet form.
